(19) United States
(12) Patent Application Publication
(10) Pub. No.: US 2006/0248729 A1
(43) Pub. Date: Nov. 9, 2006

(54) Tape breaking device

(76) Inventor: T. Russell Shivas, Toronto (CA)

Correspondence Address: GREENBERG TRAURIG, LLP, ONE INTERNATIONAL PLACE, 20th FL, ATTN: PATENT ADMINISTRATOR, BOSTON, MA, 02110, US

(21) Appl. No.: 10/562,084

(22) PCT Filed: Jun. 17, 2004
(86) PCT No.: PCT/CA04/00899

§ 371 Date: Jun. 2, 2006

Related U.S. Application Data
(60) Provisional application No. 60/480,656, filed on Jun. 23, 2003.

(51) Int. Cl. B26B 3/00

(52) U.S. Cl. 30/165; 206/216

(57) ABSTRACT

A tape breaking device includes a ring (12) and at least one pointed protrusion (16) extending outward along an axis from an outer circumferential surface of the ring (13). The ring (12) has an inner dimension sized to fit over a user's finger. The invention also provides a taping kit comprising a roll of tape, a tape breaking device as described above, and a unitary package. The package comprises a substantially planar sheet member supporting the tape roll and the tape breaking device on one surface thereof, and an at least partially transparent cover disposed over the tape roll and the tape breaking device, and extending from points on the surface disposed about the tape roll and the tape breaking device.

### FIELD OF THE INVENTION

The present invention relates to tape breaking devices, more particularly, to devices which are operable with one hand when used for breaking tapes.

### BACKGROUND

Adhesive tape, for example, transparent tape having an adhesive on one side, is widely used in packaging and other working environments. Such tape is generally used in a roll and with a tape cutting or breaking device for cutting a piece from the roll. One type of conventional tape breaking device is housed in a tape dispenser, which generally includes a handle, a tape storage station mounted on the handle and having a tape dispensing port, and a serrated breaking edge or blade disposed close to the tape dispensing port. In a preferred use, a distal end portion of the tape is pulled out of the tape storage station from the tape dispensing port and after a desired length of the tape has been pulled out, by pressing the breaking edge of the blade, the tape is cut off at the breaking edge.

Dispensers tend to twist the tape and become hazardous when reloading or realigning the tape because the tape may re-adhere itself to the roll and result in loss of the tape. Also, large dispensers are heavy and difficult to operate with one hand.

People also use scissors, knife, teeth, or a pen or pencil to cut the tape. Such methods may cause an uneven break. All these devices generally require use of a second hand or the user's teeth.

What is needed therefore is a tape breaking device which is safe, simple, convenient, and can be easily operated with one hand.

### SUMMARY OF THE INVENTION

A tape breaking device in accordance with the present invention generally includes a ring having an open section and at least one pointed protrusion extending outward along an axis from an outer circumferential surface of the ring.

In one preferred embodiment, the ring is resilient, has an oval shape and is sized to fit over one of a user's fingers, preferably the thumb. Also, the open section of the ring makes the inner dimension of the ring adjustable so that the ring can snugly fit to a user's thumb. The tape breaking device preferably includes three protrusions extending opposite the open section of the ring. The protrusions have pointed distal ends for breaking the adhesive tape. In alternative embodiments, the tape breaking device may have one, two, three or more protrusions.

In one preferred embodiment, the tape breaking device has three protrusions, the protrusions each preferably extend along an axis X, wherein the axes X of all the three protrusions are substantially parallel to each other. Each protrusion extends a distance such that the distal tips of the protrusions are positioned substantially in one plane, preferably in one straight line, which extends substantially perpendicular to the axes X. In an alternative embodiment, the middle protrusion of the three protrusions may extend a greater distance, and the other two protrusions may extend a shorter distance. In another preferred embodiment of the tape breaking device, the axes X of the protrusions are angularly offset, preferably in a diverging pattern.

In another preferred embodiment, the tape breaking device includes a continuous ring instead of a ring having an open section.

The device is preferably made from non-metal resilient material, for example, plastic, or polycarbonate materials. Alternatively the ring can be made of metal. The device is preferably resilient, but also can be rigid.

In another preferred embodiment, a taping kit comprises a roll of tape having an adhesive on one side, a tape breaking device which is the tape breaking device described above, and a unitary package. The package preferably includes a substantially planar sheet member which supports the tape roil and the tape breaking device, and an at least partially transparent cover disposed over the tape roll and the tape breaking device. The transparent cover preferably is molded with two depressions, one is sized to receive the tape roll and the other is sized to receive the tape breaking device. The transparent cover may further includes a substantially planar portion which extends from points on the outer surface of the two depressions which are disposed about the tape roll and tape breaking device. The transparent cover and the substantially planar sheet member are preferably made from plastic and are mounted together by melting the peripheral edges of the cover to the peripheral edges of the substantially planar sheet member. The cover and the substantially planar sheet member also can be coupled together by other means, for example, by stitches.

In a preferred use, a roll of tape is positioned over one or more fingers, then the tape breaking device is placed on the user's thumb with the protrusions facing the tape, and after a desired length of the tape is rolled out, the user presses down with his thumb with the tape breaking device placed thereon against the tape, and the protrusions pierce the tape and cut the tape. The user also can place his index finger under the tape for applying counter pressures against the tape when the tape breaking device is pressed downward against the tape. After the tape is cut, the end of the tape will reset on the index finger which will help to grip the tape end for next use.

### BRIEF DESCRIPTION OF THE DRAWINGS

FIG. 1 is a perspective view of one preferred embodiment in accordance with the present invention;

FIG. 2 is a perspective view of another preferred embodiment in accordance with the present invention;

FIG. 3 is a perspective view of an alternative embodiment in accordance with the present invention;

FIG. 4 is a perspective view of another alternative embodiment in accordance with the present invention;

FIG. 5 is a perspective view of another preferred embodiment in accordance with the present invention; and

FIG. 6 shows a tape breaking device, and

FIG. 7 shows a kit, in accordance with the present invention in use with a cellophane tape.

### DETAILED DESCRIPTION OF THE PREFERRED EMBODIMENTS

A tape breaking device in accordance with the present invention generally includes a ring having an open section and at least one pointed protrusion extending outward along an axis from an outer circumferential surface of the ring.

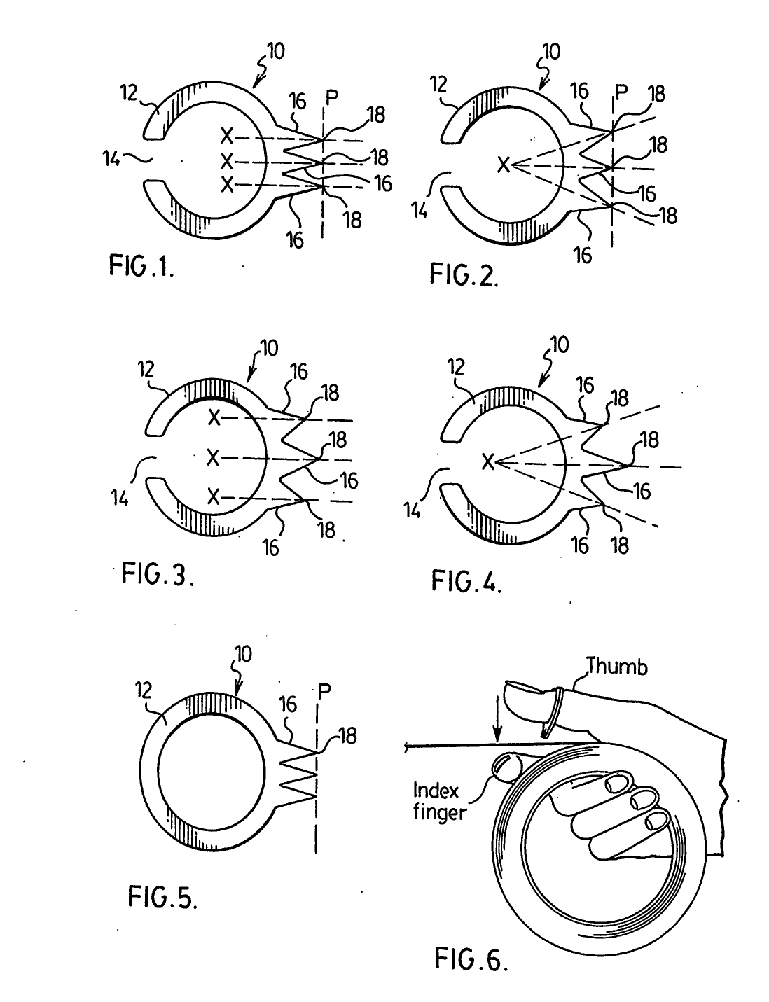

Referring to FIG. 1, in one preferred embodiment, the tape breaking device 10 includes a ring 12 having an open section 14 and three protrusions 16 extending outward from an outer circumferential surface of the ring 12. The ring 12 preferably has an oval shape and has an inner dimension sized to fit one of a user's fingers, preferably the thumb. In cases where the ring is resilient, the open section 14 of the ring 12 makes the inner dimension of the ring 12 adjustable so that the ring can snugly fit to a user's thumb.

The protrusions 16 preferably extend opposite the open section 14 of the ring 12 and have pointed distal ends 18 for cutting the adhesive tape. In the preferred embodiment shown in FIG. 1, the device 10 has three protrusions. In alternative embodiments, the tape breaking device may have one, two, three or more protrusions.

The protrusions 16 each preferably extend along an axis X. In the exemplary embodiment of FIG. 1, the axes X of all the three protrusions 16 are substantially parallel to each other. Each protrusion 16 extends a distance such that the distal tips 18 of the protrusions are positioned substantially in one plane, preferably in one straight line as denoted by P, which extends perpendicular to the axes X.

FIGS. 2-5 show various alternative embodiments of the tape breaking device according to the present invention. FIG. 2 illustrates a preferred embodiment of the tape breaking device, in which the axes X of the protrusions are angularly off-set. In a divergent pattern, all the pointed distal tips 18 of the protrusions 16 are positioned in one line P. FIGS. 3 and 4 show embodiments in which each protrusion 16 extends a distance such that the distal tips 18 are not positioned in one line. In FIG. 3, the axes of the protrusions 16 are substantially parallel and in FIG. 4, the axes of the protrusions 16 are angularly offset.

FIG. 5 shows a preferred embodiment of the tape breaking device 10 which includes a continuous ring 12 instead of a ring having an open section as shown in FIGS. 14.

The device is preferably made from resilient material, for example, plastic, or polycarbonate materials. Alternatively, the device can be made of metal. The device is preferably resilient, but also can be rigid.

FIG. 6 shows a use of the tape breaking device 10 where the device is placed on a user's thumb and is used to cut a cellophane shipping tape from a roll disposed over two of the user's fingers. The device is positioned so that its protrusions are opposite the tape. In a preferred use, after a desired length of the tape is rolled out, the user presses his thumb against the tape with the result that protrusions 16 pierce the tape and cut the tape. To effect quicker cutting, the user also can place another finger, for example, index finger, under the tape for applying counter pressure against the tape, as shown in FIG. 6, when the tape breaking device is pressed against the tape. After the tape is cut, the end of the tape will reset on the index finger which will help to grip the tape end for next use.

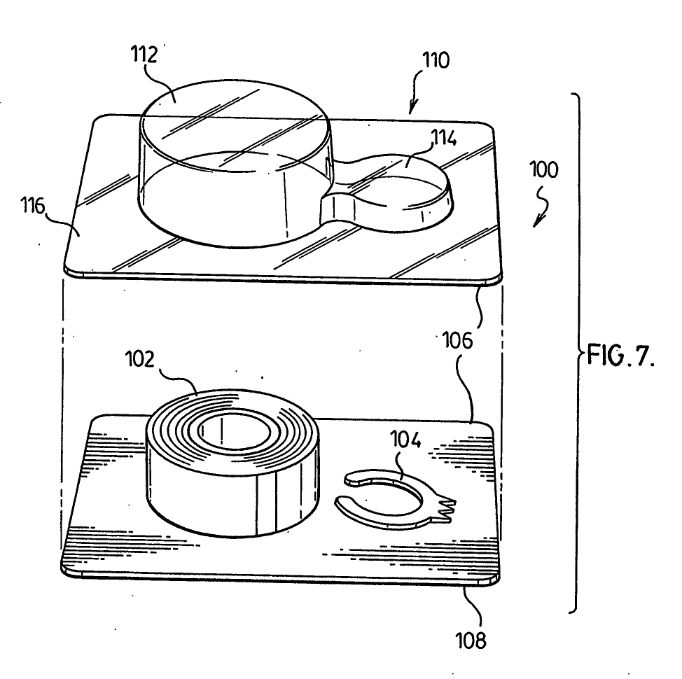

FIG. 7 illustrates a kit 100 in accordance with one preferred embodiment of the present invention. The kit 100 includes a roll of tape 102 which has an adhesive on one side, a tape breaking device 104 which is the tape breaking device described above, and a unitary package 106. The package 106 preferably includes a substantially planar sheet member 108 which supports the tape roll 102 and the tape breaking device 104, and an at least partially transparent cover 110 disposed over the tape roll 102 and the tape breaking device 104. As shown in FIG. 7, the transparent cover 100 preferably is molded with depressions 112 and 114, wherein the depression 112 is sized to receive the tape roll 102 and the depression 114 is sized to receive the tape breaking device 104. The transparent cover 100 may further includes a substantially planar portion 116 which extends from points on the outer surface of the depressions 112 and 114 which are disposed about the tape roll 102 and tape breaking device 104. The transparent cover 110 and the substantially planar sheet member 108 are preferably made from plastic and are mounted together by melting the peripheral edges of the cover 110 and the substantially planar sheet member 108. The cover 110 and the substantially planar sheet member 108 also can be coupled together by other means, for example, by stitches.

While the preferred embodiments and method of use of the invention have been illustrated and described in some detail in the drawings and foregoing description, it should be understood that this description is made only by way of example to set forth the best mode contemplated of carrying out the invention and not as a limitation to the scope of the invention which is pointed out by the claims below.

### TAPE BREAKING DEVICE

### FIELD OF THE INVENTION

The present invention relates to tape breaking devices, more particularly, to devices which are operable with one hand when used for breaking tapes.

### BACKGROUND

Adhesive tape, for example, transparent tape having an adhesive on one side, is widely used in packaging and other working environments. Such tape is generally used in a roll and with a tape cutting or breaking device for cutting a piece from the roll. One type of conventional tape breaking device is housed in a tape dispenser, which generally includes a handle, a tape storage station mounted on the handle and having a tape dispensing port, and a serrated breaking edge or blade disposed close to the tape dispensing port. In a preferred use, a distal end portion of the tape is pulled out of the tape storage station from the tape dispensing port and after a desired length of the tape has been pulled out, by pressing the breaking edge of the blade, the tape is cut off at the breaking edge.

Dispensers tend to twist the tape and become hazardous when reloading or realigning the tape because the tape may re-adhere itself to the roll and result in loss of the tape. Also, large dispensers are heavy and difficult to operate with one hand.

People also use scissors, knife, teeth, or a pen or pencil to cut the tape. Such methods may cause an uneven break. All these devices generally require use of a second hand or the user's teeth.

What is needed therefore is a tape breaking device which is safe, simple, convenient, and can be easily operated with one hand.

### SUMMARY OF THE INVENTION

A tape breaking device in accordance with the present invention generally includes a ring having an open section and at least one pointed protrusion extending outward along an axis from an outer circumferential surface of the ring.

In one preferred embodiment, the ring is resilient, has an oval shape and is sized to fit over one of a user's fingers, preferably the thumb. Also, the open section of the ring makes the inner dimension of the ring adjustable so that the ring can snugly fit to a user's thumb. The tape breaking device preferably includes three protrusions extending opposite the open section of the ring. The protrusions have pointed distal ends for breaking the adhesive tape. In alternative embodiments, the tape breaking device may have one, two, three or more protrusions.

In one preferred embodiment, the tape breaking device has three protrusions, the protrusions each preferably extend along an axis X, wherein the axes X of all the three protrusions are substantially parallel to each other. Each protrusion extends a distance such that the distal tips of the protrusions are positioned substantially in one plane, preferably in one straight line, which extends substantially perpendicular to the axes X. In an alternative embodiment, the middle protrusion of the three protrusions may extend a greater distance, and the other two protrusions may extend a shorter distance. In another preferred embodiment of the tape breaking device, the axes X of the protrusions are angularly offset, preferably in a diverging pattern.

In another preferred embodiment, the tape breaking device includes a continuous ring instead of a ring having an open section.

The device is preferably made from non-metal resilient material, for example, plastic, or polycarbonate materials. Alternatively the ring can be made of metal. The device is preferably resilient, but also can be rigid.

In another preferred embodiment, a taping kit comprises a roll of tape having an adhesive on one side, a tape breaking device which is the tape breaking device described above, and a unitary package. The package preferably includes a substantially planar sheet member which supports the tape roll and the tape breaking device, and an at least partially transparent cover disposed over the tape roll and the tape breaking device. The transparent cover preferably is molded with two depressions, one is sized to receive the tape roll and the other is sized to receive the tape breaking device. The transparent cover may further includes a substantially planar portion which extends from points on the outer surface of the two depressions which are disposed about the tape roll and tape breaking device. The transparent cover and the substantially planar sheet member are preferably made from plastic and are mounted together by melting the peripheral edges of the cover to the peripheral edges of the substantially planar sheet member. The cover and the substantially planar sheet member also can be coupled together by other means, for example, by stitches.

In a preferred use, a roll of tape is positioned over one or more fingers, then the tape breaking device is placed on the user's thumb with the protrusions facing the tape, and after a desired length of the tape is rolled out, the user presses down with his thumb with the tape breaking device placed thereon against the tape, and the protrusions pierce the tape and cut the tape. The user also can place his index finger under the tape for applying counter pressures against the tape when the tape breaking device is pressed downward against the tape. After the tape is cut, the end of the tape will reset on the index finger which will help to grip the tape end for next use.

### BRIEF DESCRIPTION OF THE DRAWINGS

FIG. 1 is a perspective view of one preferred embodiment in accordance with the present invention;

FIG. 2 is a perspective view of another preferred embodiment in accordance with the present invention;

FIG. 3 is a perspective view of an alternative embodiment in accordance with the present invention;

FIG. 4 is a perspective view of another alternative embodiment in accordance with the present invention;

FIG. 5 is a perspective view of another preferred embodiment in accordance with the present invention; and

FIG. 6 shows a tape breaking device, and

FIG. 7 shows a kit, in accordance with the present invention in use with a cellophane tape.

### DETAILED DESCRIPTION OF THE PREFERRED EMBODIMENTS

A tape breaking device in accordance with the present invention generally includes a ring having an open section and at least one pointed protrusion extending outward along an axis from an outer circumferential surface of the ring.

Referring to FIG. 1, in one preferred embodiment, the tape breaking device 10 includes a ring 12 having an open section 14 and three protrusions 16 extending outward from an outer circumferential surface of the ring 12. The ring 12 preferably has an oval shape and has an inner dimension sized to fit one of a user's fingers, preferably the thumb. In cases where the ring is resilient, the open section 14 of the ring 12 makes the inner dimension of the ring 12 adjustable so that the ring can snugly fit to a user's thumb.

The protrusions 16 preferably extend opposite the open section 14 of the ring 12 and have pointed distal ends 18 for cutting the adhesive tape. In the preferred embodiment shown in FIG. 1, the device 10 has three protrusions. In alternative embodiments, the tape breaking device may have one, two, three or more protrusions.

The protrusions 16 each preferably extend along an axis X. In the exemplary embodiment of FIG. 1, the axes X of all the three protrusions 16 are substantially parallel to each other. Each protrusion 16 extends a distance such that the distal tips 18 of the protrusions are positioned substantially in one plane, preferably in one straight line as denoted by P, which extends perpendicular to the axes X.

FIGS. 2-5 show various alternative embodiments of the tape breaking device according to the present invention. FIG. 2 illustrates a preferred embodiment of the tape breaking device, in which the axes X of the protrusions are angularly off-set. In a divergent pattern, all the pointed distal tips 18 of the protrusions 16 are positioned in one line P. FIGS. 3 and 4 show embodiments in which each protrusion 16 extends a distance such that the distal tips 18 are not positioned in one line. In FIG. 3, the axes of the protrusions 16 are substantially parallel and in FIG. 4, the axes of the protrusions 16 are angularly offset.

FIG. 5 shows a preferred embodiment of the tape breaking device 10 which includes a continuous ring 12 instead of a ring having an open section as shown in FIGS. 1-4.

The device is preferably made from resilient material, for example, plastic, or polycarbonate materials. Alternatively, the device can be made of metal. The device is preferably resilient, but also can be rigid.

FIG. 6 shows a use of the tape breaking device 10 where the device is placed on a user's thumb and is used to cut a cellophane shipping tape from a roll disposed over two of the user's fingers. The device is positioned so that its protrusions are opposite the tape. In a preferred use, after a desired length of the tape is rolled out, the user presses his thumb against the tape with the result that protrusions 16 pierce the tape and cut the tape. To effect quicker cutting, the user also can place another finger, for example, index finger, under the tape for applying counter pressure against the tape, as shown in FIG. 6, when the tape breaking device is pressed against the tape. After the tape is cut, the end of the tape will reset on the index finger which will help to grip the tape end for next use.

FIG. 7 illustrates a kit 100 in accordance with one preferred embodiment of the present invention. The kit 100 includes a roll of tape 102 which has an adhesive on one side, a tape breaking device 104 which is the tape breaking device described above, and a unitary package 106. The package 106 preferably includes a substantially planar sheet member 108 which supports the tape roll 102 and the tape breaking device 104, and an at least partially transparent cover 110 disposed over the tape roll 102 and the tape breaking device 104. As shown in FIG. 7, the transparent cover 100 preferably is molded with depressions 112 and 114, wherein the depression 112 is sized to receive the tape roll 102 and the depression 114 is sized to receive the tape breaking device 104. The transparent cover 100 may further includes a substantially planar portion 116 which extends from points on the outer surface of the depressions 112 and 114 which are disposed about the tape roll 102 and tape breaking device 104. The transparent cover 110 and the substantially planar sheet member 108 are preferably made from plastic and are mounted together by melting the peripheral edges of the cover 110 and the substantially planar sheet member 108. The cover 110 and the substantially planar sheet member 108 also can be coupled together by other means, for example, by stitches.

While the preferred embodiments and method of use of the invention have been illustrated and described in some detail in the drawings and foregoing description, it should be understood that this description is made only by way of example to set forth the best mode contemplated of carrying out the invention and not as a limitation to the scope of the invention which is pointed out by the claims below.

I claim:

1. A tape breaking device comprising:
a ring having an open section;
at least one pointed protrusion extending outward along an axis from an outer circumferential surface of said ring.

2. A tape breaking device according to claim 1, wherein said pointed protrusion extends from a part of said outer circumferential surface, wherein said part is opposite to said open section.

3. A tape breaking device according to claim 1, wherein said at least one pointed protrusion comprises two or more protrusions.

4. A tape breaking device according to claim 3, wherein said protrusions each extend along an axis, wherein said axes of said protrusions are substantially parallel.

5. A tape breaking device according to claim 3, wherein said protrusions each extend along an axis, wherein said axes are angularly offset.

6. A tape breaking device according to claim 3, wherein said protrusions comprise distal tips, wherein said protrusions each extend a distance, such that said distal tips are substantially positioned in one line.

7. A tape breaking device according to claim 1, wherein said at least one protrusions comprises three protrusions.

8. A tape breaking device according to claim 7, wherein said three protrusions extend along axes, said axes being substantially parallel.

9. A tape breaking device according to claim 8, wherein said three protrusions each extend along an axis, said axes of said protrusions are angularly offset.

10. A tape breaking device according to claim 8, wherein said three protrusions have distal tips, wherein said protrusions each extend a distance, such that said distal tips are substantially positioned in one line which is substantially perpendicular to the axis of a middle protrusion of said three protrusions.

11. A tape breaking device according to claim 1, wherein said device is made of a resilient material.

12. A tape breaking device according to claim 1, wherein said device is made of plastic.

13. A tape breaking device according to claim 1, wherein said ring is oval-shaped.

14. A tape breaking device according to claim 1, wherein said ring has an inner dimension sized to fit over a human finger.

15. A tape breaking device comprising:
a ring having an inner dimension sized to fit over a human finger;
at least one pointed protrusion extending outward along an axis from an outer circumferential surface of said ring.

16. A tape breaking device according to claim 16, wherein said at least one pointed protrusion comprises three protrusions.

17. A tape breaking device according to claim 17, wherein said protrusions comprise distal tips, said distal dips being positioned substantially in one line which is substantially perpendicular to said axis of a middle protrusion of said three protrusions.

18. A taping kit comprising:
A. a roll of tape, said tape having an adhesive on one side;
B. a tape breaking device, said device comprising:
a ring having an open section; and
at least one pointed protrusion extending outward along an axis from an outer circumferential surface of said ring; and
C. a unitary package comprising:
i. a substantially planar sheet member supporting said tape roll and said tape breaking device on one surface thereof; and
ii. an at least partially transparent cover disposed over said tape roll and said tape breaking device, and extending from points on said surface disposed about said tape roll and said tape breaking device.

19. A tape breaking device according to claim 18, wherein said at least partially transparent cover is molded with a first depression sized to receive said tape roll and a second depression sized to receive said tape breaking device.

20. A tape breaking device according to claim 18, wherein said at least partially transparent cover and said substantially planar sheet member are mounted together by melting peripheral edges of said at least partially transparent cover to peripheral edges of said substantially planar sheet member.
